(19) United States
(12) Patent Application Publication
(10) Pub. No.: US 2005/0039804 A1
(43) Pub. Date: Feb. 24, 2005

(54) Impulse valve structure of apparatus for suppling inert gas alternately

(76) Inventor: Woong Ki kim, Gangnam-gu (KR)

Correspondence Address: SUGHRUE MION, PLLC, 2100 PENNSYLVANIA AVENUE, N.W., SUITE 800, WASHINGTON, DC, 20037, US

(21) Appl. No.: 10/488,837

(22) PCT Filed: Sep. 5, 2003
(86) PCT No.: PCT/KR03/01832

(30) Foreign Application Priority Data
Sep. 13, 2002 (KR) 10-2002-0055770

(51) Int. Cl. F16K 11/06

(52) U.S. Cl. 137/625.48

(57) ABSTRACT

The present invention relates to an impulse valve structure which can prevent the pressure drop within the impulse valve and the vibration of a spool when inert gases are supplied alternately. The impulse valve structure comprises: a hollow body (210) having a first and a second gas inlets (211, 212) and a gas outlet (213); a spool (220) inserted into the inside of the hollow body (210) to partition a first and a second gas chambers (261, 262) and to alternately discharge the inert gases by means of straight reciprocal movement; a plurality of plunger guides (240) connected on the opposite ends peripheral surfaces of the hollow body (210) for securing a stopper (230); and a first and a second solenoids (251, 252) disposed on the peripheral surfaces of the plunger guide (240) for providing the magnetic force enabling the straight reciprocal movement of the spool (220).

### TECHNICAL FIELD OF THE INVENTION

The present invention relates to an impulse valve structure of an apparatus for supplying inert gas alternately, more particularly, to the impulse valve structure which can prevent the pressure drop within the impulse valve and the vibration of a spool when inert gases are supplied alternately, by changing the structure of the impulse valve, and has fins for efficiently radiate the heat generated from solenoid coils.

### BACKGROUND OF THE INVENTION

In general, an inert gas tungsten arc welding (TIG) suitable for welding base metals having thickness ranging from 0.6 mm to 3 mm and an inert gas metal arc welding (MIG) for welding base metals having thickness of 3 mm or higher have been widely used as an inert gas arc welding.

Such inert gas arc welding in which an electric arc is generated between the base metals and a tungsten rod or a metal wire electrode under an atmosphere of the inert gas which has been known to show no reaction with metals at even a high temperature is widely used in manufacturing aircrafts, rockets, automobiles, machineries related to a low temperature, and railway vehicles, etc.

As shown in FIG. 1, one of the prior art inert gas arc welding systems is provided with a power supply 1, a gas bottle 2 charged with inert gas such as argon gas, a gas pressure regulator 3, an electrode wire supply device 5 for supplying an electrode wire to a welding torch 7, a hose connected between the gas bottle 2 and the electrode wire supply device 5 for supplying the inert gas within the gas bottle 2 to the electrode wire supply device 5, a connection line 6 connected to the welding torch 7, and a current adjustment (not shown) electrically connected to the power supply 1 for allowing the welder to adjust the current level.

Meanwhile, as for the prior art inert gas tungsten arc welding system, it is further provided with a high frequency generating device or an air-cooled or a water-cooled cooling device (not shown).

In this inert gas arc welding system, the electric arc generated between the base metal and the electrode wire supplied through the welding torch 7 melts the electrode wire and, at the same time, the inert gas provided to the welding torch 7 isolate the welding zone and the electric arc from surrounding air.

As shown in FIG. 2, the welding torch 7 has a conductive member 7b inside a nozzle 7a and is supplied with the electrode wire 5a through an inner diameter of the conductive member 7b. The inert gas 9a isolates the electric arc 9 from the surrounding air.

At this time, a direct current or an alternating current is applied to the conductive member 7a and the base metal 8 connected to the power supply 1 and beads are formed around the welding zone 8a.

However, in the weld zone 8a produced by conventional inert gas arc welding using only homogeneous single gas medium, such as pure helium or argon, very coarse cracks are found at several portions of a weld zone 8a. When a tomography is conducted, it can be seen that weld junctions in the weld zone 8a are not connected to each other well, and the weld junctions have vertical sectional surfaces which are not uniform.

Accordingly, the base metal having such weld zone 8a experiences breaking at cracks and the junction lines, which may occur due to an external shock or aging. In addition to the breaking, the base metal has a problem that conditions of the surface thereof are different according to a kind of inert gas.

For example, in case that helium gas is used, the welded surface is not uniform and has a defected shape. Further, in case of argon gas having a good cleansing function of removing an oxidation layer, it is easy for many bubbles to be generated.

Further, in the prior art arc welding system, a direction in which ions of the inert gas is supplied and a direction in which electrons of the electrode wire is supplied are different from each other depending upon the polarity of the applied current and this significantly affects the welding results.

In order to solve said problems, KR Patent No. 0347887 owned by the present applicant discloses apparatus and a method for alternately supplying different inert gases to a welding torch. Said patent discloses apparatus and method for alternately supplying more than one kinds of inert gases to a welding torch in a periodic manner, thereby considerably improving conditions of weldment, and achieving an uniform vertical sectional surface of a weld junction.

Hereinafter, it will be described concretely about above patent. As shown in FIG. 3, main body 100 of the apparatus for an alternate supply of inert gases which is designed to be widely applied to various different arc welding systems is operated by a separate power source and has a volume of 170 mm×170 mm×60 mm and a 1.5 kg weight which enables the apparatus to be mounted at any place which the welder wants.

The main body 100 is connected to a plurality of gas bottles 20 and 30 for periodically alternately supplying different inert gases such as argon gas (Ar) or helium gas (He) to a welding torch 7 in inert gas arc welding systems.

Each of the gas bottles 20 and 30 is provided with a pressure regulator 23 or 33 which is well known in the art and communicates with an inlet hose 41 or 42 and a discharge hose 43 for supplying the gases to the welding torch 7.

Further, the inert gas arc welding system is provided with a core wire supply device 5 for a supply of a wire electrode, a connection line 6, and a power source 1 for supplying electricity required for a welding process.

As shown in FIG. 4, the main body 100 for a periodically alternate supply of the different inert gases from the gas bottles 20 and 30 includes an electronic controller 110, a display panel 120, an input key pad 130, a power supply 140, and a gas mixer 150 (it is so called impulse valve) for a mixing of the gases and a pressure regulation.

The power supply 140 receives an approximately 220V AC voltage and provides both an output voltage of an approximately 36V AC or DC voltage and an output voltage of an approximately 5V DC voltage. The 36V voltage is for operating a plurality of solenoids of the gas mixer 150, whereas the 5V voltage is for operating a controller circuit within the electronic controller 110, a LCD indicator of the display panel 120, and a circuit for the input key pad 130.

The input key pad 130 which is configured in a same manner as that of the conventional key input device is used to input information for selecting a control mode, e.g., a kind and thickness of the base metal, a welding process or the use of cutting.

The display panel 120 allows the welder to confirm the control mode selected by the electronic controller 110 based on the input date and the conventional “LCD” or “FND Display” may be used for the display panel 120.

The electronic controller 110 is constituted with a plurality of electronic devices for performing control functions serves to perform alternately applying and cutting-off the 36V voltage to/from the solenoids of the gas mixer 150 at frequency ranging from about 2 Hz to 20 Hz.

Under control of the electronic controller 110, the gas mixer 150 properly mixes the gas introduced through a first gas inlet tube 101 with the gas introduced through a second gas inlet tube 102 and allows the mixed gas having relatively high pressure (caused by pulsation pressure) kept in a constant level to be supplied to the welding torch of the inert gas arc welding system via a mixed gas exhaust tube 103.

Such electronic controller 110 selects the control mode (e.g., an driving frequency of the solenoid is differently given according to the selected control mode) by receiving key entries through the input key pad 130, and displays the selected control mode in display panel 120.

Particularly, as shown in FIG. 5, the electronic controller 110 which controls the input key pad 130, the display panel 120, the gas mixer 150 by using power from the power supply 140 is provided with a key input connector 115a, a display connector 116a, a key input port 115b, a display output port 116b, a microprocessor 111, a program memory 112, a data memory 113, a control output port 114 for the gas mixer 150, a first gas opening/closing output port 118, a second gas opening/closing output port 119, a first transistor 117a, and a second transistor 117b.

The 5V voltage from the power supply 140 is supplied to a connection line between the key input connector 115a and the key input port 115b in a parallel connection therewith, via a first input line 141, whereas the 36V voltage is connected to the first and the second transistors 117a, 117b via a second input line 142.

The key input port 1 Sb and the display output port 116b are connected to a bus for a signal processing of the microprocessor 111 in a parallel relationship therewith.

The data memory 113 keeps therein reference data, e.g., the kind and the thickness of material of which the base metal is made, the use of welding, the use of cutting, in a form of, e.g., data sheet, on which determining or selecting the driving frequency (about 2 Hz to 20 Hz) of the solenoid is based.

The microprocessor 111 is operated based on a control logic stored in the program memory 112 and generates a first gas opening/closing control signal 114a and a second gas opening/closing control signal 114b alternately.

Such control signals 114a and 114b are amplified by the first transistor 117a and the second transistor 117b, respectively, and are sent to the first gas opening/closing output port 118 and the second gas opening/closing output port 119, respectively, via a rectifier circuit.

Accordingly, the microprocessor 111 of the electronic controller 110 can allow a first solenoid 151 and a second solenoid 152 provided in the gas mixer 150 to be in opposite states of ON or OFF to each other, by using such the first gas opening/closing output port 118 and the second gas opening/closing output port 19.

As shown in FIGS. 6 and 7, the gas mixer 150 is provided with the first solenoid 151, the second solenoid 152, and a T-shaped tube 153 inserted between the solenoids.

The first solenoid 151 and the second solenoid 152 generate magnetic forces which are exerted in an opposite direction to each other and serve to move a gas opening/closing device 154 back and forth within the T-shaped tube 153, when electricity is alternately applied to the solenoids 151 and 152 via the first and the second gas opening/closing output ports 118 and 119.

The T-shaped tube 153 which communicates with the first gas inlet tube 101, the second gas inlet tube 102 and the mixed gas discharge tube 103 is provided with therein a centered main chamber 158 and gas chambers 159 positioned on both lateral portions of the main chamber 158, respectively.

Partitions each of which has a through hole through which the gas opening/closing device 154 is moved divide the T-shaped tube into such gas chambers 159 and the main chamber 158. Heads 155 of the gas opening/closing device 154 are inserted into the partitions, respectively.

The gas opening/closing device 154 is constituted with a center rod and the heads 155 integrally formed with both ends of the center rod.

Further, the heads 155 have guide bars 157 formed on outward ends of the heads 155, respectively, which can be inserted into the first gas inlet tube 101 and the second gas inlet tube 102, respectively, so that the gas opening/closing device 154 can alternately closing inner diameters of the first gas inlet tube 101 and the second gas inlet tube 102, moving back and forth within the T-shaped tube.

Further, each of the heads 155 of the gas opening/closing device 154 has a conic shape at its outward end, which is convergent in a direction toward the first gas inlet tube 101 or the second gas inlet tube 102, a plurality of slits 156 formed on its peripheral surface.

The slits 156 which can be formed in a linear form or a helical form serve to change vortex flow of the gas into linear flow, which may easily occur in opening/closing portions of the first and the second gas inlet tubes 101 and 102 and the gas chambers 159.

Accordingly, in the main chamber 158 of the T-shaped tube 153, irregular flow of the gas caused by an occurrence of the pulsation pressure is minimized during passing through the slits 156 of the heads 155.

Further, the mixed gas having relatively high pressure due to the occurrence of the pulsation pressure is supplied to the welding torch 7 of the inert gas arc welding system via the mixed gas discharge tube 103.

Such mixed gas having as its components different kinds of inert gases, e.g., Argon gas (Ar) or Helium gas (He) causes a good condition of the result by the welding process since different componential inert gases each of which has its own welding characteristic are alternately emitted from a nozzle of the welding torch 7 via the gas mixer 150 of an apparatus for an alternate supply of inert gases.

Hereunder, a method of alternately supplying the inert gases using the apparatus for the alternate supply of the inert gases described above will be described.

As shown in FIG. 8, the main body 100 of the inventive alternate gas-supply apparatus is connected to the inlet hoses of the gas bottles which are charged with argon gas and helium gas, respectively (S10).

Then, the main body 100 is switched on and the inert gas arc welding system is also switched on at the same time.

At the moment, electricity is applied to the electronic controller 110 and the is display panel 120, thereby bringing the gas mixer 150 into a stand-by state for its operation, which will apply a mechanical stimulation and pressure to the base metal depending upon the kind of the base metal 80.

At this time, the welder or the operator inputs information on, for example, the kinds and the size of the base metal to be welded by using the input key pad 130 (S20), and confirms the control mode determined by the input information through the display panel 120 (S30).

Next, in the inventive apparatus for the alternate supply of the inert gases, the power is alternately applied to the first solenoid and the second solenoid, i.e., while one is powered on, the other is powered off or vice versa, at the frequency corresponding to the determined control mode to drive the gas opening/closing device 154 (S40).

That is, when the electronic controller outputs the first gas opening/closing control signal, the 36V voltage is applied to the first solenoid (while the line for the second gas opening/closing control signal is shorted out) to allow the first solenoid 151 to attract the gas opening/closing device by the magnetic force caused by the applied power.

For this reason, the first gas inlet tube 101 is closed, while the second gas inlet tube 102 being opened to cause the argon gas to be introduced into the main chamber 158 of the T-shaped tube 153.

After time interval determined by the driving frequency for the solenoid, the electronic controller 110 outputs the second gas opening/closing control signal, the 36V voltage is instantly applied to the second solenoid 152 (while the line for the first gas opening/closing control signal is shorted out) to allow the second solenoid 152 to attract the gas opening/closing device 154 by the magnetic force caused by the applied power.

For this reason, the second gas inlet tube 102 is closed, while the first gas inlet tube 101 being opened to cause the helium gas to be introduced into the main chamber 158 of the T-shaped tube 153.

The argon gas and the helium gas sequentially and alternately introduced into the main chamber 158 of the T-shaped tube 153 are properly mixed with each other and discharged through the mixed gas discharge tube 103 of the gas mixer 150 under a constant level of pressure.

The different kinds of inert gases introduced into the gas mixer 150 by the operation of the gas opening/closing device 154 in the above-described manner are alternately supplied to the nozzle of the welding torch 7 (S50).

After that, the welder can perform the welding process by positioning the welding torch 7 near the base metal 80 (S50), confirming the condition of the welding (S60).

That is, the applicant has found that, in the base metal 80 welded by the inert gas arc welding system equipped with the inventive apparatus for the alternate supply of the different inert gases, when a tomography is conducted, only fine cracks are found on rare occasions at the weld zone of the base metal 80 having relatively reduced bubbles. It has been also found that a weld junction connects the base metals in a form of substantial straight lines.

Further, a vertical sectional surface of the weld junction which has been found uniform can minimize breaking which may easily occur due to an external shock or aging.

Table 1 shown below represents the comparison between the inert gas arc welding system equipped with the apparatus described above and the conventional welding system.

TABLE 1

| | | | Welding | Gas flow | Percentage |
|---|---|---|---|---|---|
| Automatic | | Thickness | current | Rate | of impurity |
| Welding | Material | (mm) | (A) | (L/min) | content (%) |
| Prior art | Aluminum | 3.2 | 400 | 12 | 0.3 or |
| Apparatus | plate | | | | higher |
| | Steel | 2.4 | 160˜250 | 9 | 0.1 or |
| | plate | | | | higher |
| Inventive | Aluminum | 3.2 | 280 | 8.4 | Lower |
| Apparatus | plate | | | | than 0.09 |
| | Steel | 2.4 | 110˜170 | 4 | Lower |
| | plate | | | | than 0.02 |

As shown in Table 1, the alternate supply of argon gas and helium gas has a reduced power consumption by 30% than that in the prior art arc welding using same kinds of gases. The inventive apparatus has not only a better weld result but also a welding accuracy increased by 15% to 20% than those in the prior art. Further, the weldment obtained by inventive apparatus has impurity content reduced by three times to five times than that by the prior art. In addition, the inventive apparatus has a more reduced consumption of the inert gases which are known as expensive by 30% to 50% than that of the prior art apparatus.

Said apparatus for the alternate supply of the different inert gases is designed to permit both advantages of the argon gas having an outstanding cleansing function and the helium gas causing an even weld surface, to be exerted by alternately supplying both gases, thereby resulting in a remarkably evened weld surface, and can minimize the occurrence of the crack and the breaking of the weld and result in the uniform vertical sectional surface of the weld junction.

In the apparatus for the alternate supply of the different inert gases having said advantages, the gas mixer 150 comprises the gas opening/closing device 154 which is designed so as to open/close selectively the first gas inlet tube 101 and the second gas inlet tube 102 within the T-shaped tube 153 using magnetic force from the first solenoid 151 and the second solenoid 152. The gas opening/closing device 154 has a center rod and the heads 155 integrally formed at opposite ends of the center rod. A plurality of slits 156 is axially formed in outer peripheral surface of the heads 155 to change vortex flow of the gas into linear flow. Inert gases such as argon gas and helium gas are alternately introduced through the slits 156, and the introduced inert gases are mixed in the main chamber 158 through the gas chambers 159 formed in left and right. After this, the mixed inert gases are discharged through the mixed gas discharge tube 103, or alternately and periodically supplied.

It is preferred that argon gas and helium gas introduced periodically into the main chamber 158 of T-shaped tube 153 are sequentially introduced and properly mixed so as to discharge from the mixed gas discharge tube 103 of the gas mixer 150 to the nozzle of the welding torch while maintaining substantially constant pressure.

However, inert gas such as argon gas and helium gas introduced through the first and the second gas inlet tubes 101, 102 is not passed uniformly through the plural slits 156 in course of introducing the inert gas through slit 156. Furthermore, pressure drop is caused while the gas passes through the slits 156, so that accuracy for controlling pressure change in response to the gas supply control is lowered slightly.

Furthermore, because high pressure affects the gas opening/closing device 154 while the gas passes through the slits 156, the gas opening/closing device 154 is trembled to generate the noise due to vibration (trembling).

Moreover, in case of the gas mixer 150, the first solenoid 151 and the second solenoid 152 are wound in the opposite directions each other on the outer peripheral surface of T-shaped tube. Power is supplied from the first gas opening/closing output port 118 and the second gas opening/closing output port 119 to the first solenoid 151 and the second solenoid 152, so that magnetic force is generates in opposite directions. Therefore, a large amount of heat is generated while the magnetic force is generated from the first solenoid 151 and the second solenoid 152, but the gas mixer as described above does not have any structure for radiating the generated heat to the outside.

### SUMMARY OF THE INVENTION

In view of the above-described problems of a prior art, an object of the present invention is to provide an impulse valve structure of an apparatus for an alternate supply of inert gases, which can prevent the pressure drop within the impulse valve and the vibration of a spool when inert gases are supplied alternately, by changing the structure of the impulse valve.

The other object of the present invention is to provide an impulse valve structure of an apparatus for an alternate supply of inert gases, which has fins for effectively radiating the heat generated from solenoid coils installed on the impulse valve.

The above and other objects of the invention are accomplished by providing an impulse valve structure of an apparatus for an alternate supply of inert gases adapted to periodically mix or alternately supply inert gases comprising: a hollow body having a first and a second gas inlets formed with predetermined interval therebetween on the outer peripheral surface thereof, and a gas outlet formed on the outer peripheral surface at an opposite side to the first and the second gas inlets; a spool inserted into the inside of the hollow body to partition a first and a second gas chambers corresponding to the first and the second gas inlets and to alternately discharge the inert gases introduced into the first and the second gas chambers through the first and the second gas inlets to the gas outlet by means of straight reciprocal movement; a plurality of plunger guides connected on the opposite ends peripheral surfaces of the hollow body for securing a stopper which blocks the opposite ends of the spool; and a first and a second solenoids disposed on the peripheral surfaces of the plunger guide at both ends thereof and having coils which are wound on bobbins in opposite directions each other for providing the magnetic force enabling the straight reciprocal movement of the spool.

It is preferred that the spool has a blocking partition wall at a center portion thereof, two stepped grooves having same size each other and formed at the left and right of the blocking partition wall along outer periphery thereof, and two body portions having predetermined length and the same diameter as the blocking partition wall, respectively in a symmetrical arrangement.

It is also preferred that at a diametric central portion of the spool, a gas passage is formed longitudinally from the end to the stepped groove, and at the end of the gas passage near the stepped groove, a vent hole for suctioning and exhausting the gas is formed.

It is further preferred that the width of blocking partition wall is smaller than the diameter of gas outlet.

It is further preferred that radiation fins are integrally formed on the outer peripheral surface of the hollow body with uniform intervals adjacent to the first and the second solenoids.

It is further preferred that at the side of the hollow body, a pad made of rubber or the like for absorbing the vibration is installed and the pad serves as a fixing support for fixing the impulse valve at a desired position and an absorber for absorbing the fine vibration generated due to movement of the spool within the hollow body.

It is further preferred that a buffer groove is formed at the diametric central position of the stopper, air/gas being flowed into the buffer groove for buffering function in response to the sudden pressure change between the stopper and the spool due to the movement of the spool.

An apparatus for an alternate supply of inert gases incorporating the impulse valve structure according to the present invention has a reduced power consumption by 30% than that in the prior art arc welding system, a better weld result, a welding accuracy and a more reduced consumption of the expensive inert gases by 30% to 50% than that of the prior art apparatus, by alternately supplying or periodically mixing inert gases to feed to welding zone, as is the apparatus for an alternate supply of inert gases described in the above as a prior art.

Furthermore, the inventive apparatus for an alternate supply of inert gases is designed to permit both advantages of the argon gas having an outstanding cleansing function and the helium gas causing an even weld surface, to be exerted by alternately supplying both gases, thereby resulting in a remarkably evened weld surface.

Moreover, the inventive apparatus for an alternate supply of inert gases can minimize the occurrence of the crack and the breaking of the weld zone, and results in the uniform vertical sectional surface of the weld junction.

Particularly, according to the present invention, the problem of generation of the noise due to the vibration of the gas opening/closing device and pressure drop during the flowing of gas through the impulse valve, that the prior art apparatus for an alternate supply of inert gases has, is remarkably improved.

Namely, in case of the impulse valve structure according to the present invention, because the first and the second gas inlets and the gas outlet directly communicate each other, the pressure drop is prevented in the course of supplying inert gases.

Also, the impulse valve structure has gas passages, vent holes, and buffer grooves for preventing the sudden pressure change in the course of movement of the spool within the hollow body of the impulse valve, to thereby minimize the vibration of the spool and the crashing sound by buffering the impact when the spool impinges on the stopper.

Furthermore, a pad for absorbing the vibration is mound on the side of the hollow body to absorb the vibration as possible, so that noise problem due to the vibration is remarkably improved.

In addition, the impulse valve structure according to the present invention has a radiation fins so that heat-radiation effect that is a serious problem of a solenoid in the prior apparatus is remarkably improved.

### BRIEF DESCRIPTION OF THE DRAWINGS

FIG. 1 illustrates a schematic view of a prior art inert gas arc welding system;

FIG. 2 depicts a sectional view showing principles of the welding system shown in FIG. 1;

FIG. 3 illustrates a schematic view of a welding system incorporating an apparatus for an alternate supply of inert gases in accordance with one embodiment of a prior art;

FIG. 4 is a block diagram showing a configuration of a prior art apparatus for an alternate supply of inert gases;

FIG. 5 shows a circuitry of major parts of the apparatus shown in FIG. 4;

FIG. 6 is a partial cut-away sectional view of the major parts of the apparatus shown in FIG. 4;

FIG. 7 is a sectional view of the apparatus shown in FIG. 6, when taken along a line D-D;

FIG. 8 is a block diagram showing a method of alternate supply of inert gases using the apparatus shown in FIG. 4;

FIG. 9 is a cross-sectional view showing an impulse valve structure of an apparatus for alternate supply of inert gases according to the present invention;

FIG. 10 is a side view showing an impulse valve structure of an apparatus for alternate supply of inert gases according to the present invention; and

FIGS. 11 to 13 sequentially show operation states of an impulse valve of an apparatus for alternate supply of inert gases according to the present invention.

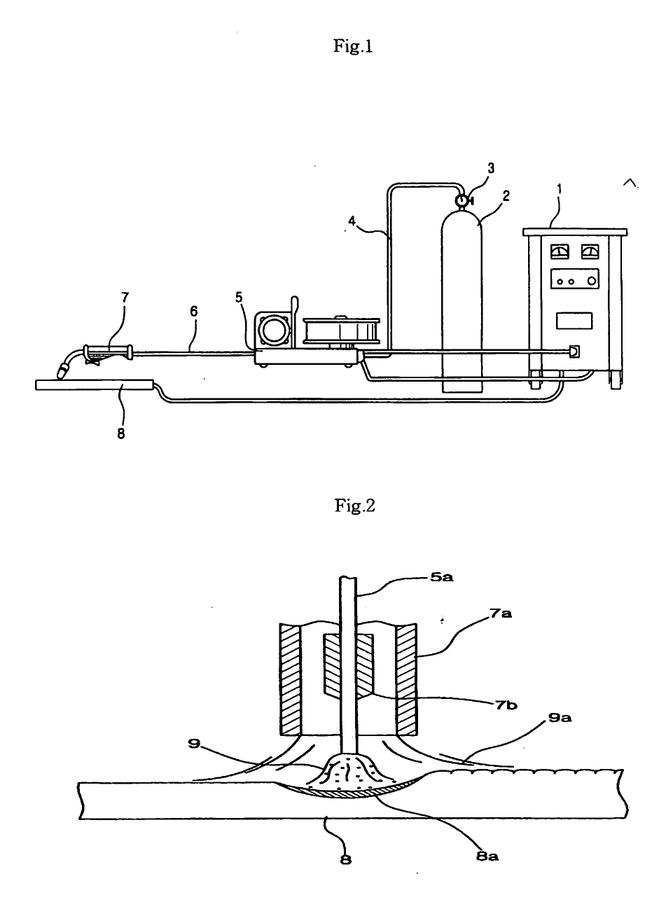

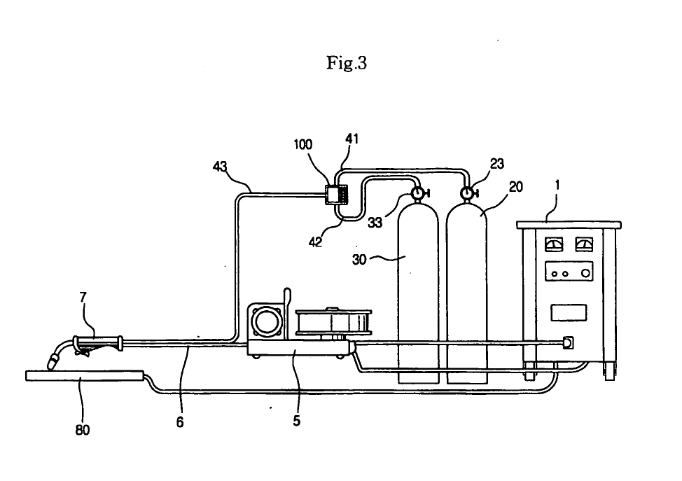

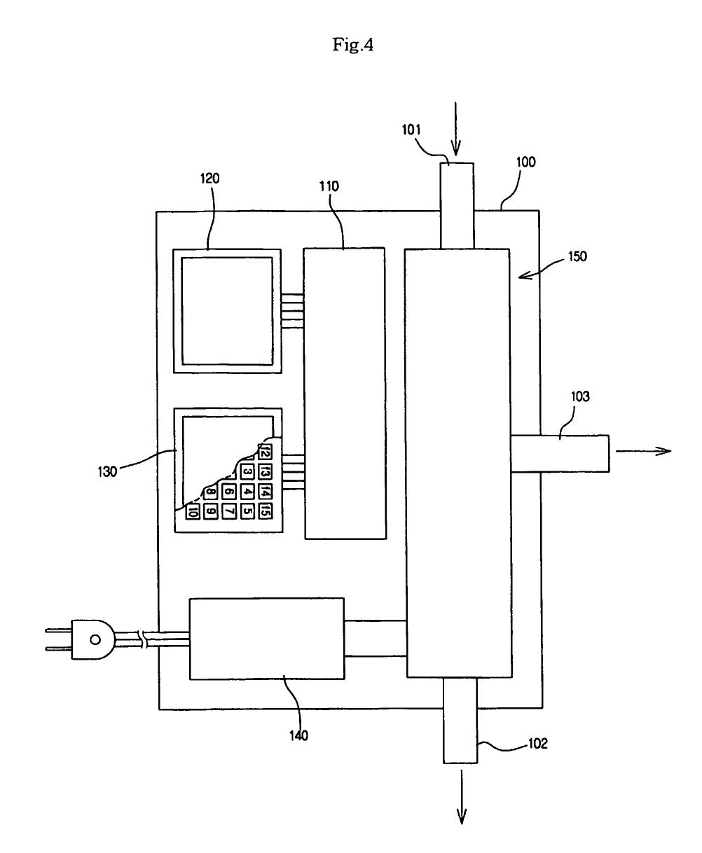

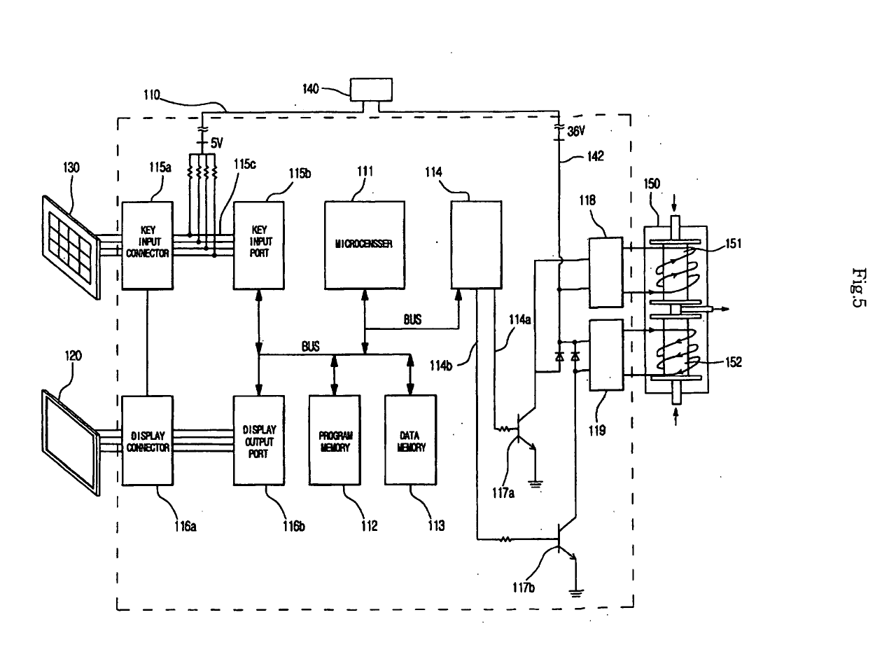

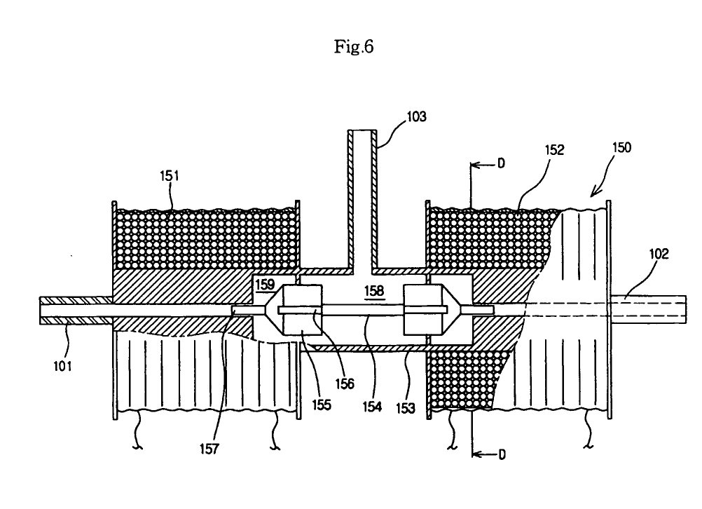

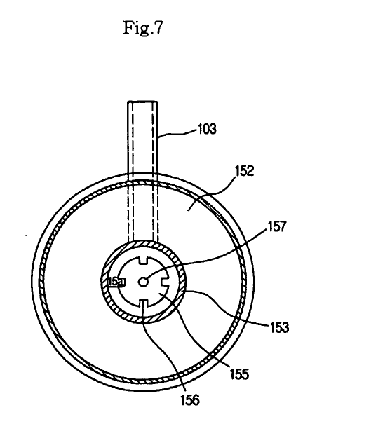

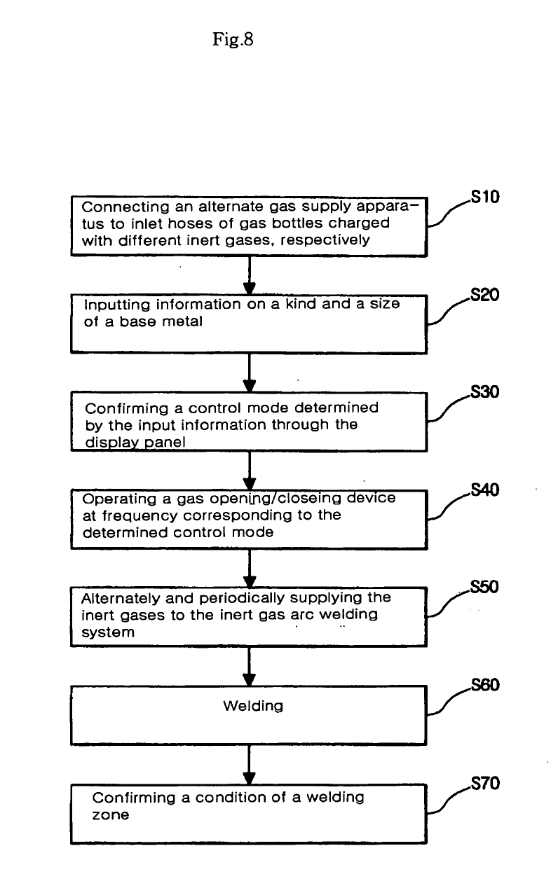

### DETAILED DESCRIPTION OF THE INVENTION

Preferred embodiment of an impulse valve structure of an apparatus for alternately supplying inert gases according to the present invention will be described below in detail with reference to accompanying drawings.

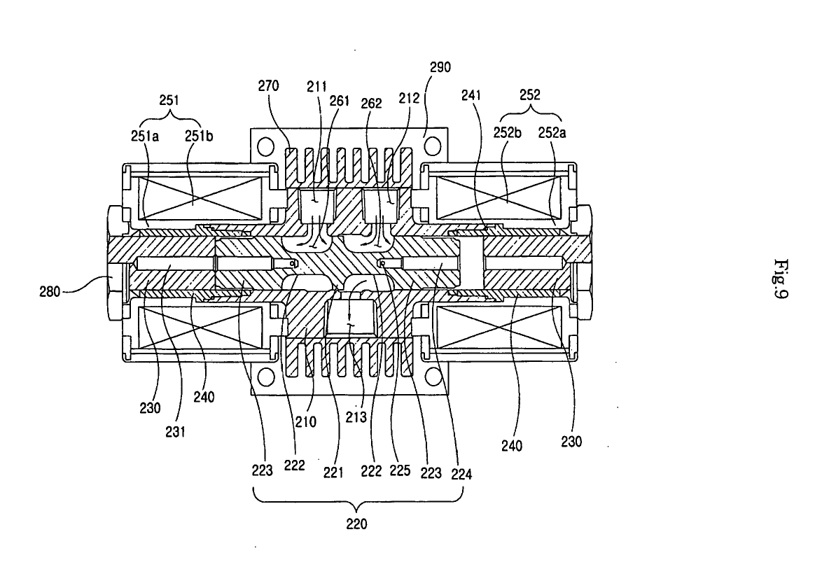

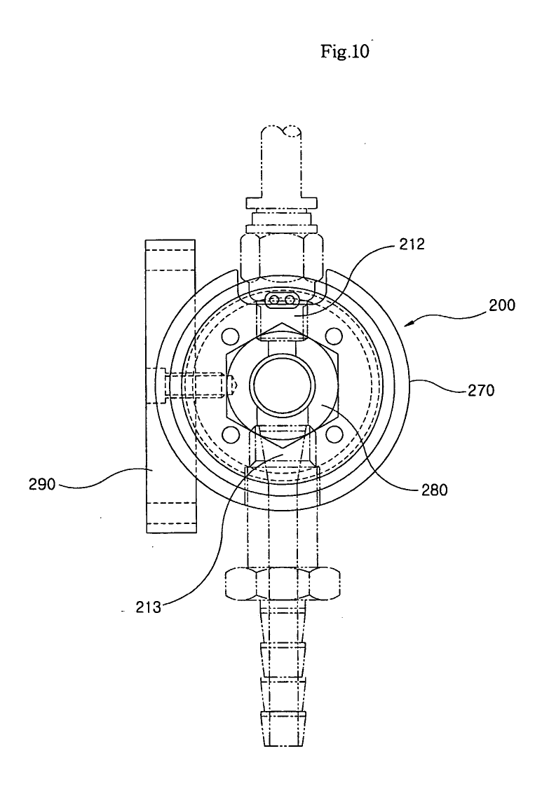

FIG. 9 is a cross-sectional view showing an impulse valve structure of an apparatus for alternately supplying inert gases according to the present invention, and FIG. 10 is a side view showing an impulse valve structure of an apparatus for alternately supplying inert gases according to the present invention.

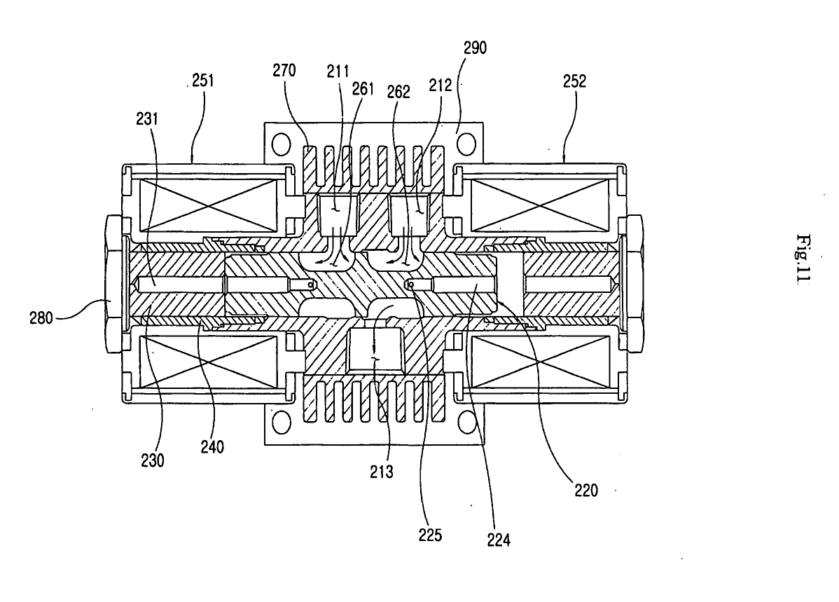

FIGS. 11 to 13 sequentially show operation states of an impulse valve of an apparatus for alternately supplying inert gases according to the present invention.

Here, in the explanation of an impulse valve structure according to the present invention, an apparatus for alternately supplying inert gases described as a prior art will be cited when the explanation thereof is necessary, because the general constitution of an apparatus for alternately supplying inert gases to which the impulse valve is applied is the same as that described as a prior art.

As shown in FIGS. 9 and 10, an impulse valve 200 of an apparatus for alternately supplying inert gases according to the present invention comprises a hollow cylindrical body 210 having a first and a second gas inlets 211, 212 formed with predetermined interval therebetween on the outer peripheral surface thereof, and a gas outlet 213 formed on the outer peripheral surface at an opposite side to the first and the second gas inlets 211, 212; a spool 220 inserted into the inside of the hollow body 210 to partition a first and a second gas chambers 261, 262 corresponding to the first and the second gas inlets 211, 212 and to alternately discharge the inert gases introduced into the first and the second gas chambers 261, 262 through the first and the second gas inlets 211, 212 to the gas outlet 213 by means of straight reciprocal movement; a plurality of plunger guides 240 connected on the opposite ends peripheral surfaces of the hollow body 210 for securing a stopper 230 which blocks the opposite ends of the spool 220; and a first and a second solenoids 251, 252 disposed on the peripheral surfaces of the hollow body 210 at both ends thereof and having coils 251b and 252b which are wound on bobbins 251a, 252a in opposite directions each other for providing the magnetic force enabling the straight reciprocal movement of the spool 220.

Referring to figures, the impulse valve 200 has a whole arrangement which is symmetrical with respect to center of the hollow body 210.

Namely, the gas outlet 213 disposed in the outer peripheral surface of the hollow body 201 is preferably positioned on the center of the hollow body 210, and the first and the second gas inlets 211, 212 disposed in the outer peripheral surface at opposite side of the gas outlet 213 are preferably positioned with the same distance from the gas outlet 213.

Further, the spool 220 inserted into the inside of the hollow body 210 has a symmetrical structure as a whole, and has a shape of a hasp or a dumbbell which has a protruded central portion.

Namely, the spool 220 has a blocking partition wall 221 at a center portion thereof, two stepped grooves 222 having same size each other and formed at the left and right of the blocking partition wall 221 along outer periphery thereof, and two body portions 223 having predetermined length and the same diameter as the blocking partition wall 221.

Therefore, when the spool 220 having above-described structure is inserted into the hollow body 210, the blocking partition wall 221 is positioned between the first gas inlet 211 and the second gas inlet 212 and a first and a second gas chambers 261, 262 are formed by the stepped grooves. The first and the second gas chambers 261, 262 serve as a passage for communicating the first and the second gas inlets 211, 212 alternately with the gas outlet 213 while the spool 220 moves reciprocally in the left and right directions.

As such, because the inert gas introduced into the first and the second gas inlet 211, 212 flows directly through gas outlet 213 via the first and the second gas chambers 261, 262, the pressure drop of inert gas introduced into the first and the second gas chambers 261, 262, respectively, does not occur.

Accordingly, the problem of prior art that the pressure drop occurs while the inert gas introduced into the left and right chambers 159 flows to the central chamber 158 via the narrow slits 156 and then discharges through the mixed gas discharge tube 103 from the central chamber 158 is overcome in principle.

The width of blocking partition wall 221 is configured to be smaller than the diameter of gas outlet 213.

Because the width of blocking partition wall 221 is configured to be smaller than the diameter of gas outlet 213, when the spool 220 moves to position the blocking partition wall 221 at the gas outlet 213, the blocking partition wall 221 does not block the gas outlet 213. Accordingly, the first and the second gas chambers 261, 262 and the gas outlet 213 directly communicate with a predetermined interval, so that two types of different inert gases such as the argon gas and helium gas introduced into the first and the second gas chambers 261, 262 are discharged simultaneously through the gas outlet 213 and supplied to a nozzle of a welding torch 7 as a mixed state.

At a diametric central portion of the spool 220, a gas passage 224 is formed longitudinally from the end to the stepped portion 222. At the end of the gas passage 224 near the stepped portion, a vent hole 225 for suctioning and exhausting the gas is formed.

When the spool 220 moves reciprocally in the longitudinal direction in the hollow body 210 by means of the magnetic force produced by the first and the second solenoids 251, 252, a space between the spool 220 and the stopper 230 is enlarged and contracted repeatedly At that time, if the space becomes a vacuum state, strong pressure is exerted so that the spool 220 could not moved.

However, in the present invention, because the gas passage 224 and the vent hole 225 are formed at the diametric central potion, the gases introduced into the first and the second gas chambers 261, 262 are freely introduced into the space and discharged to the first and the second gas chambers 261, 262 so that the spool 220 can move reciprocally in the longitudinal direction without being subjected to the pressure resistance.

Owing to free straight reciprocal movement of the spool 220, the vibration during the straight reciprocal movement of the spool 220 is also prevented.

Furthermore, the spool is generally manufactured from steel in view of durability thereof. The type of steel may be selected in consideration that the spool may be magnetized by the magnetic force of the first and the second solenoids 251, 252.

Namely, it is preferred to use a material that is not magnetized as the material of spool 220. In case of using a steel material that may be magnetized in view of cost, it is preferred to make it to be un-magnetized by appropriate treatment such as specific coating on the surface of the spool 220 and the like.

The spool 220 moves in the hollow body 210 substantially in the airtight state with respect to the inner surface of the hollow body 210 so that the inert gas does not flow along a contact surface between the spool 220 and the inner surface of the hollow body 210.

The first and the second gas inlets 211 and 212 are connected to a gas bottle (not shown) via the connection hose for feeding two different types of inert gases such as argon gas and helium gas. The gas outlet 213 is connected to a welding torch 7 via a connection hose for feeding mixed gas of two different inert gases or alternately feeding two different inert gases.

The stopper 230 disposed at the opposite ends of the hollow body 210 for blocking the both ends of the spool 220 is inserted into a plunger guide 240 and a outer peripheral surface thereof is fixed to the plunger guide 240 by welding.

At the diametric central position of the stopper 230, a buffer groove 231 into which air (inert gas in the present invention) is flow for buffering function when the spool to 220 is contacted with the stopper 230 by the magnetic force of the first and the second solenoids 251, 252 is formed.

Namely, the buffer groove 231 prevents the spool 220 from suddenly moving and impinging to the stopper 230 to generate a crashing sound while controlling the back pressure in response to the sudden pressure change between the stopper 230 and the spool 220 along with the gas passage 224 formed in the body portion 223 of the spool 220.

The plunger guide 240 is coupled on the outer peripheral surface of the hollow body 210 at both ends of the hollow body. O-ring 241 for preserving airtightness is inserted in the connection portion between the plunger guide 240 and the hollow body 210.

The first and the second solenoids 251, 252 having bobbins 251a, 252a and coils 251b, 252b wound on the bobbins are oppositely disposed on the outer peripheral surface of the plunger guide 240, and firmly fixed by nuts 280 which are fastened to the opposite ends of the plunger guide 240.

Respective coils 251b, 252b of the first and the second solenoids 251, 252 are wound in the opposite directions each other to generate magnetic power by means of the current from the power supply (not shown) and to thereby periodically (alternately) attract the spool 220.

Meanwhile, the heat is substantially generated in impulse valve 200 in the course of producing the magnetic force by receiving the current from the first and the second solenoids 251, 252. In order to effectively radiate the heat, a radiation fins 271 are integrally formed on the outer peripheral surface of the hollow body 210 adjacent the first and the second solenoids 251, 252.

The radiation fins 270 formed on the outer peripheral surface of the hollow body 210 have disk shapes except for portions of the first and the second gas inlets 211, 212 and the gas outlet 213 with uniform intervals. In order to effectively radiate the heat by enlarging the radiation area, the fins 270 are integrally formed on the outer peripheral surface of the hollow body 210 between the first and the second solenoids 251, 252 such that the fins are protruded higher than the first and the second solenoids 251, 252 to enlarge the area to be contacted with ambient air.

At the side of the hollow body 210, a pad 290 made of rubber or the like for absorbing the vibration is installed by fastening bolts, etc. The pad 209 serves as a fixing support for fixing the impulse valve 200 at a desired position and an absorber for absorbing the fine vibration generated due to movement of the spool 220 within the hollow body 210 to suppress the noise as possible.

The operation of the impulse valve 200 according to the present invention constituted as described above will be described in the below in connection with the operation of the conventional apparatus for alternately supplying the inert gases described as a prior art by applying it to the conventional apparatus.

First, the impulse valve 200 according the present invention is installed in the main body (100) of the apparatus for alternately supplying the inert gases.

Next, the fist and the second gas inlets 211, 212 provided in the impulse valve 200 mounted in the main body 100 is connected to the gas bottle 20, 30 which are filled with argon gas and helium gas, via connection hoses, respectively, and the gas outlet 213 is connected to a nozzle of the welding torch 7 via a connection hose.

Here, as an example, the first gas inlet 211 is connected to the gas bottle which is filled with the helium and the second gas inlet 212 is connected to the gas bottle which is filled with the argon gas.

Subsequently, a power supply of the main body 100 is turned on and a power supply of the inert gas arc welding system is turned on.

Then, the power is applied to the electronic controller 110 and the display panel 120, the impulse valve 200 is ready to give mechanical impulse and pressure to inert gas depending on the type of base metal to be welded.

At that time, the operator inputs the selection of material and dimensions depending on the type of base metal to be welded by means of the input key pad 130, and identify the control mode according to input value through the display panel 120.

The apparatus for alternately supplying the inert gases to which the present invention is applied operates the spool 220 of the impulse valve 200 by reciprocally turning on and off the power supplies to the solenoids with frequency corresponding to the control mode.

Then, argon gas and helium gas from the separate inert gas bottles 20, 30 are respectively introduced into the first and the second gas chamber 261, 262 formed in the hollow body 210 of the impulse valve 200 by means of the spool 220.

When the control signal is output from the electronic controller 110, 36V voltage is instantly applied to the first solenoid 251 to generate magnetic force, and the first solenoid 251 attracts the spool 220 by the magnetic force.

Accordingly, as shown in FIG. 11, the first gas chamber is prevented from communicating with the gas outlet 213 via the blocking partition wall 221, and the second gas chamber 262 directly communicate with the gas outlet 213, so that argon gas introduced into the second gas chamber 262 is discharged through the gas outlet 123.

During the movement of the spool 220, gas is freely introduced into and discharged from the space formed between the stopper 230 and the spool 220 via the gas passage 224 and the vent hole 225 which are formed in the diametric central body portion 223 of the spool 220, so that the spool 220 moves without any pressure resistance to suppress the vibration thereof as possible.

Owing to the buffer groove 231 formed in the stopper 230, the spool 220 is prevented from moving suddenly and the impact of the spool 220 on the stopper 230 is relieved.

Furthermore, the argon gas is discharged through the gas outlet 213 immediately after it is introduced into the second gas chamber 262 in a state that the second gas chamber 262 directly communicates with the gas outlet 213, so that pressure drop of argon gas upon discharge is prevented.

When the other control signal is periodically output from the electronic controller 110 in response to the driving frequency of solenoid, 36V voltage is instantly applied to the second solenoid 252 and the magnetic force formed in the second solenoid 252 attracts the spool 220 in a direction opposite to the first solenoid 251.

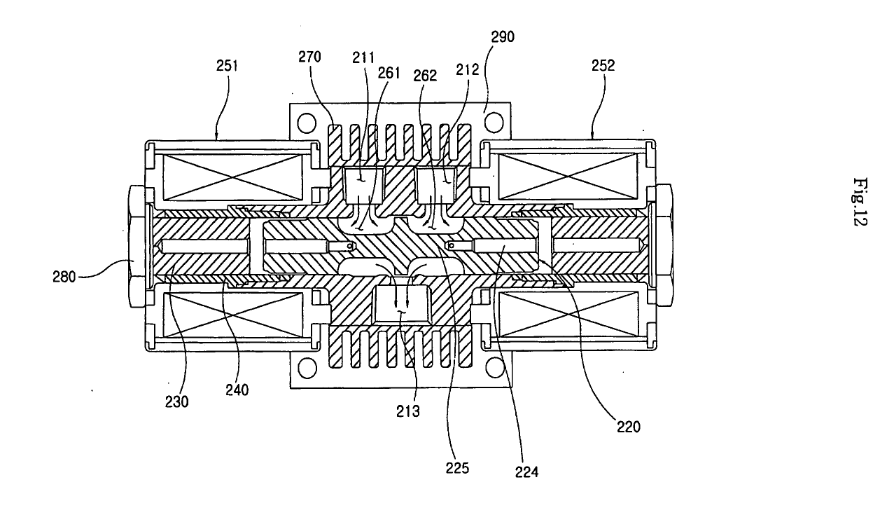

Thereby, the spool 220, which has moved toward the first solenoid 251, moves toward the second solenoid 252 and during this movement the blocking partition wall 221 arrives at the gas outlet 213 which is in a central position of the hollow body 201. As shown in FIG. 12, because the width of the blocking partition wall 221 is smaller than the diameter of the gas outlet 213, the first and the second gas chambers 261, 262 are directly communicate with the gas outlet 213, respectively, so that the helium gas and argon gas introduced into the first and the second gas chambers 261, 262 are discharged simultaneously through the gas outlet 213.

Namely, mixed gas of helium gas and argon gas is supplied to the nozzle of the welding torch 7.

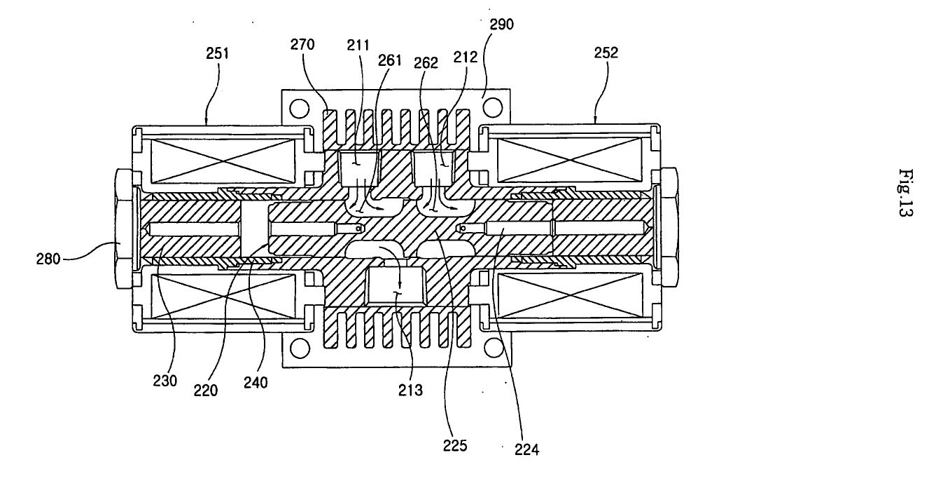

When the spool 220 is completely moved to the second solenoid 252, as shown in FIG. 13, the blocking partition wall 221 intervenes between the second gas chamber 262 and the gas outlet 213, and the first gas chamber 261 directly communicate with the gas outlet 213, so that helium gas introduced into the first gas chamber 261 is discharged through the gas outlet 213.

Also at this time, the first gas chamber 261 directly communicates with the gas outlet 213, so that pressure drop of helium gas upon discharge is prevented and constant pressure is maintained.

As described above, different types of inert gases to be supplied to the apparatus for alternately supplying the inert gases are periodically supplied to the nozzle of the welding torch 7 by mean of the reciprocal (periodic) operation of the spool 220.

Then, operator performs welding by approaching the welding torch 7 to the base metal 80 to be welded, and identify the welded state to complete the welding.

Although the apparatus and method of an alternate supply of inert gases according to the present invention has been shown and described with respect to the preferred embodiment, it will be understood by those skilled in the art that various changes and modifications may be made without departing from the spirit and scope of the invention as defined in the following claims.

Furthermore, the inventive apparatus and method of an alternate supply of inert gases may be applied to the specific arc welding system using general inert gases and other device which is operated by being supplied periodically with inert gases.

1. An impulse valve structure of an apparatus for an alternate supply of inert gases adapted to periodically mix or alternately supply inert gases comprising:
A hollow body 210 having a first and a second gas inlets 211, 212 formed with predetermined interval therebetween on the outer peripheral surface thereof, and a gas outlet 213 formed on the outer peripheral surface at an opposite side to the first and the second gas inlets 211, 212;
A spool 220 inserted into the inside of the hollow body 210 to partition a first and a second gas chambers 261, 262 corresponding to the first and the second gas inlets 211, 212 and to alternately discharge the inert gases introduced into the first and the second gas chambers 261, 262 through the first and the second gas inlets 211, 212 to the gas outlet 213 by means of straight reciprocal movement;
A plurality of plunger guides 240 connected on the opposite ends peripheral surfaces of the hollow body 210 for securing a stopper 230 which blocks the opposite ends of the spool 220; and
A first and a second solenoids 251, 252 disposed on the peripheral surfaces of the plunger guide 240 at both ends thereof and having coils 251b and 252b which are wound on bobbins 251a, 252a in opposite directions each other for providing the magnetic force enabling the straight reciprocal movement of the spool 220.

2. An impulse valve structure of an apparatus for alternate supply of inert gases according to claim 1, wherein the spool 220 has a blocking partition wall 221 at a center portion thereof, two stepped grooves 222 having same size each other and formed at the left and right of the blocking partition wall 221 along outer periphery thereof, and two body portions 223 having predetermined length and the same diameter as the blocking partition wall 221, respectively in a symmetrical arrangement.

3. An impulse valve structure of an apparatus for alternate supply of inert gases according to claim 2, wherein at a diametric central portion of the spool 220, a gas passage 224 is formed longitudinally from the end to the stepped groove 222, and at the end of the gas passage 224 near the stepped groove, a vent hole 225 for suctioning and exhausting the gas is formed.

4. An impulse valve structure of an apparatus for alternate supply of inert gases according to claim 2, wherein the width of blocking partition wall 221 is smaller than the diameter of gas outlet 213.

5. An impulse valve structure of an apparatus for alternate supply of inert gases according to claim 1, wherein radiation fins 270 are integrally formed on the outer peripheral surface of the hollow body 210 with uniform intervals adjacent to the first and the second solenoids 251, 252.

6. An impulse valve structure of an apparatus for alternate supply of inert gases according to claim 1, wherein at the side of the hollow body 210, a pad 290 made of rubber or the like for absorbing the vibration is installed and the pad 290 serves as a fixing support for fixing the impulse valve 200 at a desired position and an absorber for absorbing the fine vibration generated due to movement of the spool 220 within the hollow body 210.

7. An impulse valve structure of an apparatus for alternate supply of inert gases according to claim 1, wherein a buffer groove 231 is formed at the diametric central position of the stopper 230, air/gas being flowed into the buffer groove 231 for buffering function in response to the sudden pressure change between the stopper 230 and the spool 220 due to the movement of the spool 220.
